(19) United States
(12) Patent Application Publication
(10) Pub. No.: US 2012/0147517 A1
(43) Pub. Date: Jun. 14, 2012

(54) MULTILAYER CERAMIC CAPACITOR AND METHOD OF MANUFACTURING THE SAME

(75) Inventors: Kang Heon HUR, Seongnam (KR); Byung Gyun Kim, Jinhae (KR); Eun Sang Na, Yongin (KR); Hye Young Choi, Suwon (KR); Jai Joon Lee, Seoul (KR); Kyoung Jin Jun, Siheung (KR); Doo Young Kim, Yongin (KR)

(73) Assignee: SAMSUNG ELECTRO-MECHANICS CO., LTD.

(21) Appl. No.: 13/316,010

(22) Filed: Dec. 9, 2011

(30) Foreign Application Priority Data
Dec. 10, 2010 (KR) 10-2010-0126121

(51) Int. Cl. H01G 4/30; H01G 7/00

(52) U.S. Cl. 361/301.4; 29/25.42

(57) ABSTRACT

There are provided a multilayer ceramic capacitor and a method of manufacturing the same. The multilayer ceramic capacitor according to the embodiment of the present invention includes a capacitor body in which inner electrodes including a first electrode material and dielectric layers are alternately stacked; a diffusion barrier layer formed on an outer surface of the capacitor body to be electrically connected to the inner electrodes, including the first electrode material, and having a thickness of 1 μm to 10 μm; and a first outer electrode layer formed to cover the diffusion barrier layer and including a second electrode material having a lower reactivity to oxygen than the first electrode material.

### CROSS-REFERENCE TO RELATED APPLICATIONS

This application claims the priority of Korean Patent Application No. 10-2010-0126121 filed on Dec. 10, 2010, in the Korean Intellectual Property Office, the disclosure of which is incorporated herein by reference.

### BACKGROUND OF THE INVENTION

1. Field of the Invention

The present invention relates to a multilayer ceramic capacitor and a method of manufacturing the same, and more particularly, to a multilayer ceramic capacitor and a method of manufacturing the same, capable of preventing the occurrence of cracks and a degradation in chip reliability by solving outer electrode contact defects and non-plating problems and preventing excessive diffusion from outer electrodes to inner electrodes.

2. Description of the Related Art

Generally, multilayer ceramic capacitors include a plurality of ceramic dielectric sheets and inner electrodes inserted therebetween. Multilayer ceramic capacitors may allow for the implementation of product miniaturization and high capacitance and may be easily mounted on a substrate. For this reason, multilayer ceramic capacitors have been widely used as capacitive parts in various electronic devices.

Recently, as demand for small and multi-functional electronic products has increased, chip parts have tended to be miniaturized and multi-functionalized. As a result, small, high-capacity multilayer ceramic capacitors have been in demand. To this end, a multilayer ceramic capacitor, in which a thickness of a dielectric layer is 20 μm or less and an amount of layers thereof is 500 or more, has been manufactured.

Among ceramic capacitor surfaces, outer electrodes are disposed on surfaces on which ends of the inner electrodes are exposed. Generally, a conventional conductive paste used for forming outer electrodes generally includes a copper powder in which glass frit, abase resin, an organic vehicle, or the like, are mixed.

The outer electrodes are manufactured by applying an outer electrode paste to surfaces of the ceramic capacitor and sintering a metal powder included in the outer electrode paste by firing the ceramic capacitor to which the outer electrode paste is applied.

In the case of a lightly multilayered ceramic capacitor, cracks may not be generated due to diffusion from the outer electrodes to the inner electrodes, even in the case that a diffusion layer between the outer electrodes and the inner electrodes is sufficiently formed. Therefore, there has been a focus on reducing deviations in capacitance by improving contact performance between the outer electrodes and the inner electrodes through polishing technologies, an outer electrode paste composition, and outer electrode firing methods.

However, in the case of a super-capacity highly multilayered ceramic capacitor, even in the case that contact performance between the outer electrodes and the inner electrodes is improved, serious problems that are not present in lightly multilayered ceramic capacitors may occur. In detail, when diffusion from the outer electrodes to the inner electrodes of a highly multilayered ceramic capacitor is generated excessively, cracks may be generated due to the expansion in volume of the inner electrodes, flexural strength may be reduced due to the generated cracks, and product reliability may be degraded due to the penetration of plating solution through the cracks.

### SUMMARY OF THE INVENTION

An aspect of the present invention provides a multilayer ceramic capacitor and a method of manufacturing the same capable of solving contact defects and non-plating problems of outer electrodes while securing capacitance, and preventing the occurrence of cracks in inner electrodes and degradation in the reliability of chips due to diffusion of an electrode material.

According to an aspect of the present invention, there is provided a multilayer ceramic capacitor, including: a capacitor body in which inner electrodes including a first electrode material and dielectric layers are alternately stacked; a diffusion barrier layer formed on an outer surface of the capacitor body to be electrically connected to the inner electrodes, including the first electrode material, and having a thickness of 1 μm to 10 μm; and a first outer electrode layer formed to cover the diffusion barrier layer and including a second electrode material having a lower reactivity to oxygen than the first electrode material.

The first electrode material may be nickel (Ni), palladium (Pd), and an alloy thereof.

The second electrode material maybe copper (Cu), silver (Ag), platinum (Pt), and an alloy thereof.

The multilayer ceramic capacitor may further include a second outer electrode layer including nickel (Ni) formed on the first outer electrode layer by a plating method.

The multilayer ceramic capacitor may further include a third outer electrode layer including tin (Sn) formed on the second outer electrode layer by a plating method.

A total thickness of the diffusion barrier layer and the first outer electrode layer may be 22 μm or less.

According to another aspect of the present invention, there is provided a method of manufacturing a multilayer ceramic capacitor, the method including: forming a capacitor body in which inner electrodes including a first electrode material and dielectric layers are alternately stacked; forming a diffusion barrier layer by applying a conductive paste including the first electrode material to the capacitor body, the diffusion barrier layer being formed on an outer surface of the capacitor body to be electrically connected to the inner electrodes; simultaneously firing the capacitor body and the diffusion barrier layer; and forming a first outer electrode layer by applying an outer electrode paste to cover the diffusion barrier layer and firing the outer electrode paste, the outer electrode paste including a second electrode material having a lower reactivity to oxygen than the first electrode material.

The diffusion barrier layer may have a thickness of 1 μm to 10 μm.

The method may further include forming a second outer electrode layer including nickel (Ni) on the first outer electrode layer by a plating method after the forming of the first outer electrode layer.

The method may further include forming a third outer electrode layer including tin (Sn) on the second outer electrode layer by a plating method after the forming of the second outer electrode.

The first electrode material may be nickel (Ni), palladium (Pd), and an alloy thereof.

The second electrode material maybe copper (Cu), silver (Ag), platinum (Pt), and an alloy thereof.

A total thickness of the diffusion barrier layer and the first outer electrode may be 22 μm or less.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view of a multilayer ceramic capacitor according to an embodiment of the present invention;

FIG. 2 is a cross-sectional view taken along line A-A′ of FIG. 1;

FIG. 3A is a cross-sectional view taken along line B-B′ of FIG. 1; and

FIG. 3B is a cross-sectional view of a multilayer ceramic capacitor according to another embodiment of the present invention.

### DETAILED DESCRIPTION OF THE INVENTION

Hereinafter, embodiments will be described in detail with reference to the accompanying drawings so that they can be easily practiced by those skilled in the art to which the present invention pertains. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In addition, like reference numerals denote parts performing similar functions and actions throughout the drawings.

It will be understood that when an element is referred to as being “connected with” another element, it can be directly connected with the other element or may be indirectly connected with the other element having element(s) interposed therebetween. Unless explicitly described to the contrary, the word “comprise” and variations such as “comprises” or “comprising,” will be understood to imply the inclusion of stated elements but not the exclusion of any other elements.

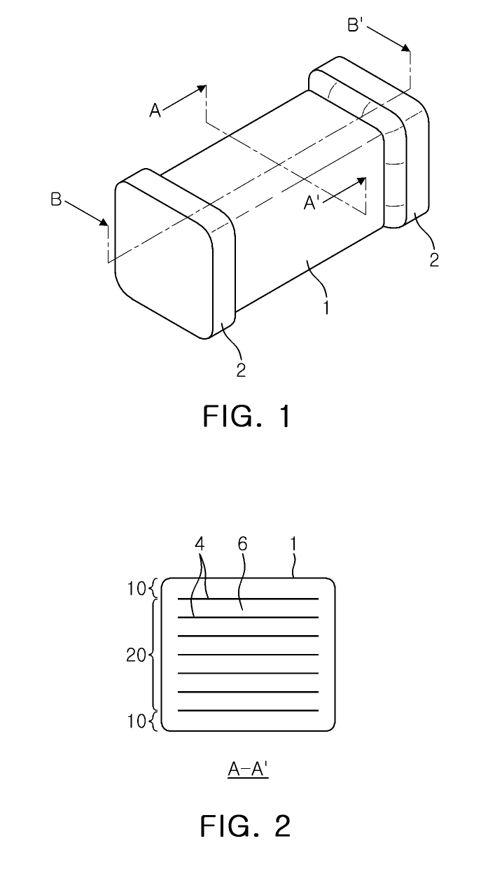

Hereinafter, a multilayer ceramic capacitor and a method of manufacturing the same will be described with reference to FIGS. 1 to 3.

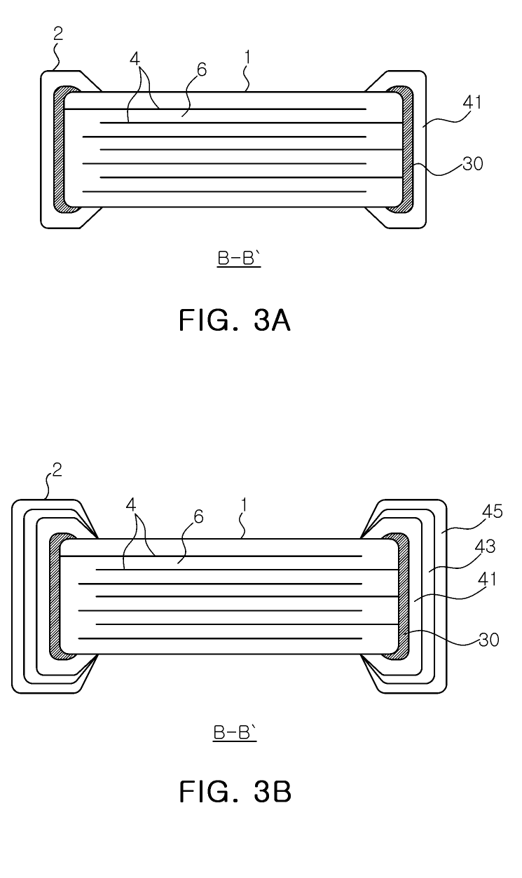

FIG. 1 is a perspective view of a multilayer ceramic capacitor according to an embodiment of the present invention, FIG. 2 is a cross-sectional view taken along line A-A′ of FIG. 1, and FIG. 3A is a cross-sectional view taken along line B-B′ of FIG. 1. Further, FIG. 3B is a cross-sectional view of a multilayer ceramic capacitor according to another embodiment of the present invention.

Referring to FIG. 1, a multilayer ceramic capacitor according to an embodiment of the present invention may include a capacitor body 1 and outer electrodes 2.

The capacitor body 1 has a plurality of dielectric layers 6 multilayered therein and inner electrodes 4 inserted between the plurality of dielectric layers 6. In this configuration, the dielectric layer 6 may be a ceramic dielectric layer formed of ceramic.

The inner electrodes 4 maybe formed of a first electrode material including nickel (Ni), palladium (Pd), and an alloy thereof. In addition, the outer electrodes 2 formed on both end surfaces of the capacitor body electrically connected to the inner electrodes 4 may be formed of a second electrode material including copper (Cu), silver (Ag), platinum (Pt), and an alloy thereof.

The outer electrodes 2 may serve as external terminals by being electrically connected to the inner electrodes 4 exposed to outer surfaces of the capacitor body 1.

The multilayer ceramic capacitor may include an active layer 20 in which the dielectric layers 6 and the inner electrodes 4 are alternately stacked. In addition, a top surface and a bottom surface of the active layer 20 may include cover layers 10 in which the dielectric layers are multilayered.

The cover layer 10 may be formed by continuously stacking the plurality of dielectric layers on the top surface and the bottom surface of the active layer 20 and may protect the active layer 20 from an external impact or the like.

The active layer 20 is a portion for securing the capacitance of the multilayer ceramic capacitor. Therefore, as the thickness of the active layer 20 is increased, a high-capacitance capacitor may be realized.

The size of the multilayer ceramic capacitor is standardized. In a case in which the thickness of the active layer 20 is excessively increased, the thicknesses of the cover layer and the outer electrodes are thinned, thereby causing a degradation in chip durability and chip defects.

In addition, in a case in which the thicknesses of the cover layer and the outer electrodes are increased, the durability and stability of chips are increased, however, since the thickness of the active layer is thinned, it is difficult to implement capacity.

Therefore, there is a need to manufacture the cover layer and the outer electrodes to have a stabilized structure and shape while securing the thickness of the active layer.

Meanwhile, in manufacturing the chip capacitor, when the inner electrodes 4 of the active layer 20 are formed of nickel (Ni), a thermal expansion coefficient thereof is about 13×10⁻⁸/° C. The dielectric layers 6 formed of ceramic have a thermal expansion coefficient of about 8×10⁻⁸/° C. Due to a difference between the thermal expansion coefficients of the dielectric layers 6 and the inner electrodes 4, when thermal impact is applied thereto during a process of mounting the capacitor body on a circuit board by firing, reflow soldering, or the like, stress may be applied to the dielectric layers 6. Therefore, cracks may occur in the dielectric layers 6 due to the stress caused by the thermal impact.

In addition, when diffusion from the outer electrodes 2 to the inner electrodes 4 is excessive, cracks may occur due to the volume expansion of the inner electrodes 4. Product reliability may be degraded due to the penetration of plating solution through the cracks occurring as described above.

FIG. 3A shows an example of a cross-sectional view taken along line B-B′ of FIG. 1. The multilayer ceramic capacitor includes the capacitor body 1 in which the dielectric layers 6 and the inner electrodes 4 are alternately stacked, and a diffusion barrier layer 30 and the outer electrodes 2 formed on both ends of the capacitor body 1. Further, the outer electrode 2 may be formed of a first outer electrode layer 41.

The diffusion barrier layer 30 prevents the second electrode material from being diffused to the inner electrodes 4 while allowing an appropriate amount of the material of the diffusion barrier layer 30 to be diffused to the inner electrodes 4, thereby improving contact performance with the outer electrodes 2. Therefore, the multilayer ceramic capacitor according to the embodiment of the present invention may stably secure capacitance and prevent the occurrence of cracks due to thermal impact and volume expansion of the inner electrodes 4.

The diffusion barrier layer 30 maybe formed on at least one of both ends of the inner electrodes 4 and formed inside the outer electrode 2 to have a thickness of 1 μm to 10 μm, thereby preventing diffusion from the outer electrode 2 to the inner electrodes 4 without affecting the thickness of the outer electrode 2.

When the thickness of the diffusion barrier layer 30 is below 1 μm, the diffusion barrier layer 30 may not prevent diffusion from the outer electrode 2 to the inner electrodes 4. When the thickness of the diffusion barrier layer 30 exceeds 10 μm or more, the thickness of the outer electrode 2 is excessively increased, such that the multilayered number of active layer may not be secured. As a result, it is difficult to secure capacitance.

According to the embodiment of the present invention, the diffusion barrier layer 30 maybe formed of the same material as that of the inner electrodes 4. For example, nickel (Ni), palladium (Pd), and an alloy thereof may be used for the diffusion barrier layer 30.

The diffusion barrier layer 30 may be manufactured by a plating method. For example, plating solution including Ni is applied to both ends of the capacitor body to form the thin diffusion barrier layer 30. The plating method is not limited thereto, but may be an electroless plating method.

After the diffusion barrier layer 30 is formed on the ceramic capacitor body 1, the first outer electrode layer 41 may be formed of an outer electrode paste including the second electrode material, glass frit, and an organic vehicle produced in a base resin and an organic solvent.

The diffusion barrier layer 30 serves to allow for desired capacitance by diffusing a predetermined amount of the material of the diffusion barrier layer 30 to the inner electrodes 4 while preventing the material of the outer electrode 2, that is, the first outer electrode layer 41 from being excessively diffused to the inner electrodes 4.

The diffusion barrier layer 30 is formed of a material having excellent electron affinity such as nickel, thereby being easily oxidized. Therefore, the diffusion barrier layer 30 may be easily oxidized while simultaneously fired with the capacitor body 1.

When the diffusion barrier layer 30 is oxidized, an oxide film may be formed on the diffusion barrier layer 30. This oxide film may cause contact defects and plating defects of the outer electrode.

However, according to the embodiment of the present invention, the first outer electrode layer 41 may be formed of a material having a lower reactivity to oxygen than the material of the diffusion barrier layer 30. Therefore, the first outer electrode layer 41 is formed on the diffusion barrier layer 30 to thereby prevent the diffusion barrier layer 30 from being oxidized.

In addition, the organic material included in the outer electrode paste forming the first outer electrode layer 41 serves to remove the oxide film formed on the diffusion barrier layer 30 through a de-binder process while simultaneously fired.

Therefore, the first outer electrode layer 41 protects the diffusion barrier layer 30 and removes the oxide film formed on the diffusion barrier layer 30, thereby improving contact performance with the outer electrode and preventing the plating defects of the outer electrode.

According to the embodiment of the present invention, a total thickness of the diffusion barrier layer 30 and the first outer electrode layer 41 may be 22 μm or less. The reason is that as the thicknesses of the outer electrode and the diffusion barrier layer are increased, the thickness of the active layer capable of securing capacitance is reduced.

FIG. 3B is a cross-sectional view of a multilayer ceramic capacitor according to another embodiment of the present invention.

The dielectric layers 6 and the inner electrodes 4 are alternately stacked in the capacitor body 1. Further, the outer electrodes 2 are respectively formed on both ends of the capacitor body 1. The diffusion barrier layer 30 is formed between the outer electrode 2 and the capacitor body 1 to prevent the diffusion of the outer electrode 2. The outer electrode 2 may include a first outer electrode layer 41, a second outer electrode layer 43, and a third outer electrode layer 45.

The second outer electrode layer 43 and the third outer electrode layer 45 are sequentially formed on the first outer electrode layer 41 by a plating method to thereby improve the solderability and corrosion resistance of the outer electrode.

The second outer electrode layer 43 including nickel (Ni) may be formed on the first outer electrode layer 41 by a plating method. Further, the third outer electrode layer 45 including tin (Sn) may be formed on the second outer electrode layer 43 by a plating method.

The first outer electrode layer 41, the second outer electrode layer 43, and the third outer electrode layer 45 form the outer electrode 2 to serve to electrically connect the inner electrodes with an external element.

According to the embodiment of the present invention, the multilayer ceramic capacitor and the method of manufacturing the same, capable of preventing cracks due to the diffusion of the electrode material while stably securing the capacitance, may be provided.

In addition, according to the embodiment of the present invention, the cracks in the multilayer ceramic capacitor may be prevented to thereby avoid a degradation in chip reliability due to the penetration of plating solution through the cracks.

Hereinafter, a method of manufacturing a multilayer ceramic capacitor according to an embodiment of the present invention will be described below.

The dielectric layers 6 of the capacitor body 1 may be formed of a slurry including a binder, a plasticizer, and a dielectric material. The conductive inner electrodes 4 are printed by applying the first electrode material to the dielectric layers 6 obtained by the application of the slurry.

A laminate having a predetermined thickness, that is, the capacitor body 1 is manufactured by stacking the dielectric layers 6 having the inner electrodes 4 printed thereon. Further, the diffusion barrier layer 30 is formed by applying the conductive paste including the first electrode material to the capacitor body 1 by a plating method. The first electrode material may be nickel (Ni), palladium (Pd), and an alloy thereof without being limited thereto. The capacitor body 1 having the diffusion barrier layer 30 formed thereon is simultaneously fired to thereby densify the diffusion barrier layer 30 and the capacitor body 1.

In this case, since the diffusion barrier layer 30 is formed of a material being easily oxidized, the oxide film may be formed on the surface of the diffusion barrier layer 30. In a case in which the oxide film is not removed later, the contact performance of the outer electrode is degraded and the plating defects thereof may be caused.

In the related art, there is a need to perform a separate process for removing the oxide film. According to the embodiment of the present invention, the oxide film may be removed by the forming and firing of the first outer electrode layer 41.

After the diffusion barrier layer 30 and the capacitor body 1 are simultaneously fired, the outer electrode paste including the second electrode material having a lower reactivity to oxygen than the first electrode material, the glass frit, and the organic vehicle is applied to cover the diffusion barrier layer. The second electrode material may be copper (Cu), silver (Ag), platinum (Pt),and an alloy thereof that are capable of protecting the diffusion barrier layer, but is not limited thereto.

Further, the organic materials included in the first outer electrode layer 41 are removed by sintering the first outer electrode layer 41. In particular, while the organic materials included in the outer electrode paste are removed through a de-binder process, the oxide film formed on the surface of the diffusion barrier layer 30 may be removed together. Therefore, the contact performance of the outer electrode may be improved and the plating defects thereof may be prevented.

Referring to FIG. 3B, for solderability and corrosion resistance, nickel (Ni) is plated on the first outer electrode layer 41, thereby forming the second outer electrode layer 43. Further, tin (Sn) is plated on the second outer electrode layer 43, thereby forming the third outer electrode layer 45.

### EXAMPLE

When multilayer ceramic capacitors were manufactured to include only the diffusion barrier layer, or only the first outer electrode layer, or when the multilayer ceramic capacitor was manufactured to include both the diffusion barrier layer and the first outer electrode layer, the characteristics thereof were compared.

Here, the diffusion barrier layer was formed of nickel, and the first outer electrode layer was formed of copper. The characteristics of the multilayer ceramic capacitors were compared by controlling the thickness the diffusion barrier layer.

TABLE 1

| | Diffusion | | | | | | |
|---|---|---|---|---|---|---|---|
| | Barrier | First Outer | | | Crack | | |
| | Layer | Electrode Layer | Capacitance | Capacitance | Frequency | Reliablity | Non-plating |
| | (μm) | (μm) | (μF) | (Cpk) | (Poor/Sample) | (Poor/Sample) | (Poor/Sample) |
| Comparative | 0 | 12 | 1.09 | 2.92 | 3/30 | 1/40 | 0/2000 |
| Example1 | | | | | | | |
| Comparative | 10 | 0 | 0.74 | 0.65 | 0/30 | 0/40 | 1500/2000 |
| Example 2 | | | | | | | |
| Example 1 | 0.5 | 12 | 1.09 | 2.94 | 3/30 | 1/40 | 0/2000 |
| Example 2 | 1 | 12 | 1.08 | 2.84 | 0/30 | 0/40 | 0/2000 |
| Example 3 | 3 | 12 | 1.12 | 3.02 | 0/30 | 0/40 | 0/2000 |
| Example 4 | 5 | 12 | 1.11 | 2.95 | 0/30 | 0/40 | 0/2000 |
| Example 5 | 10 | 12 | 1.08 | 2.91 | 0/30 | 0/40 | 0/2000 |

In the case of Comparative Example 1 in which only the first outer electrode layer was formed, crack frequency was increased to degrade product reliability. In this case, since the cracks occurred in the inner electrodes due to excessive diffusion from the first outer electrode layer to the inner electrode, product reliability was degraded although capacitance was secured.

In the case of Comparative Example 2 in which only the diffusion barrier layer was formed, it could be appreciated that capacitance was not secured and the oxide film was formed on the diffusion barrier layer during the firing process of the capacitor body to cause plating defects.

In the case of Examples in which both of the diffusion barrier layer and the first outer electrode layer are formed, it could be appreciated that crack frequency was lowered while a predetermined amount of capacitance was secured. However, in the case of Example 1 in which the diffusion barrier layer had a thickness of 0.5 μm or less, diffusion from the first outer electrode layer to the inner electrode was not sufficiently prevented, whereby cracks occurred.

According to the embodiment of the present invention, the total thickness of the diffusion barrier layer and the outer electrode may be 22 μm or less. That is, even when the outer electrode is formed to have a reduced thickness, excessive diffusion from the first outer electrode layer to the inner electrodes maybe prevented to thereby avoid the occurrence of cracks in the inner electrodes and the oxide film formed on the diffusion barrier layer may be removed to thereby prevent plating defects.

According to the embodiment of the present invention, the diffusion barrier layer and the outer electrode are formed to have a thickness of 22 μm or less, and a chip defective rate may be lowered while allowing for sufficient capacitance by securing the active layer in the capacitor.

As set forth above, according to embodiments of the present invention, a multilayer ceramic capacitor and a method of manufacturing the same, capable of preventing the occurrence of cracks and degradation in chip reliability by solving contact defect and non-plating problems of outer electrodes and preventing excessive diffusion from outer electrodes to inner electrodes.

While the present invention has been shown and described in connection with the embodiments, it will be apparent to those skilled in the art that modifications and variations can be made without departing from the spirit and scope of the invention as defined by the appended claims.

What is claimed is:

1. A multilayer ceramic capacitor, comprising:
a capacitor body in which inner electrodes including a first electrode material and dielectric layers are alternately stacked;
a diffusion barrier layer formed on an outer surface of the capacitor body to be electrically connected to the inner electrodes, including the first electrode material, and having a thickness of 1 μm to 10 μm; and
a first outer electrode layer formed to cover the diffusion barrier layer and including a second electrode material having a lower reactivity to oxygen than the first electrode material.

2. The multilayer ceramic capacitor of claim 1, wherein the first electrode material is nickel (Ni), palladium (Pd), and an alloy thereof.

3. The multilayer ceramic capacitor of claim 1, wherein the second electrode material is copper (Cu), silver (Ag), platinum (Pt), and an alloy thereof.

4. The multilayer ceramic capacitor of claim 1, further comprising a second outer electrode layer including nickel (Ni) formed on the first outer electrode layer by a plating method.

5. The multilayer ceramic capacitor of claim 4, further comprising a third outer electrode layer including tin (Sn) formed on the second outer electrode layer by a plating method.

6. The multilayer ceramic capacitor of claim 1, wherein a total thickness of the diffusion barrier layer and the first outer electrode layer is 22 μm or less.

7. A method of manufacturing a multilayer ceramic capacitor, the method comprising:
forming a capacitor body in which inner electrodes including a first electrode material and dielectric layers are alternately stacked;
forming a diffusion barrier layer by applying a conductive paste including the first electrode material to the capacitor body, the diffusion barrier layer being formed on an outer surface of the capacitor body to be electrically connected to the inner electrodes;
simultaneously firing the capacitor body and the diffusion barrier layer; and
forming a first outer electrode layer by applying an outer electrode paste to cover the diffusion barrier layer and firing the outer electrode paste, the outer electrode paste including a second electrode material having a lower reactivity to oxygen than the first electrode material.

8. The method of claim 7, wherein the diffusion barrier layer has a thickness of 1 μm to 10 μm.

9. The method of claim 7, further comprising forming a second outer electrode layer including nickel (Ni) on the first outer electrode layer by a plating method after the forming of the first outer electrode layer.

10. The method of claim 9, further comprising forming a third outer electrode layer including tin (Sn) on the second outer electrode layer by a plating method after the forming of the second outer electrode.

11. The method of claim 7, wherein the first electrode material is nickel (Ni), palladium (Pd), and an alloy thereof.

12. The method of claim 7, wherein the second electrode material is copper (Cu), silver (Ag), platinum (Pt), and an alloy thereof.

13. The method of claim 7, wherein a total thickness of the diffusion barrier layer and the first outer electrode is 22 μm or less.
